(19) United States
(12) Patent Application Publication
(10) Pub. No.: US 2010/0033486 A1
(43) Pub. Date: Feb. 11, 2010

(54) Method and system of determining and visualizing dependencies between industrial process parameters

(76) Inventor: Karl Erik Vilhelm Dahlen, Gothenburg (SE)

Correspondence Address: LYNN E BARBER, P O BOX 16528, FORT WORTH, TX, 76162, US

(21) Appl. No.: 12/459,306

(22) Filed: Jun. 30, 2009

Related U.S. Application Data
(60) Provisional application No. 61/077,212, filed on Jul. 1, 2008.

(51) Int. Cl. G06T 11/20

(52) U.S. Cl. 345/440.2; 345/440

(57) ABSTRACT

A method is provided of determining and visualizing dependencies between industrial process parameters with a minimum of mouse clicks.

### CROSS-REFERENCE TO RELATED APPLICATIONS

This application claims priority from U.S. Provisional Application Ser. No. 61/077,212, filed Jul. 1, 2008.

### BACKGROUND OF THE INVENTION

1. Technical Field

The invention herein relates to a method and system of determining and visualizing dependencies between industrial process parameters with a minimum of computer mouse clicks.

2. Background

In process industries and automated manufacturing industries it is common that a human operator controls and monitors the manufacturing process using computer based control systems and graphical HMI (Human machine interface).

Large manufacturing industries, such as pulp- and paper mills, and chemical industries, often have complex processes with a large number of monitored real-time process parameters, with internal dependencies that are hard to understand. Due to large production volumes, disturbances are very expensive. It is therefore essential for the human operator that controls the processes to be able to act very fast and handle any problems or deviations that occur in the manufacturing process in a secure and accurate way.

The industrial control systems are normally equipped with a graphical interface where the human operator watches near real time data and issues commands to the control system. To make it easier for the human operator to interpret process parameters such as measured values, control set points, and calculated key indexes, the parameters are normally presented in the content of a schematic view of the process.

The schematic displays provide a very good momentary view of the process situation, but it is difficult for the operator to understand process deviation in a time perspective. Graphical diagrams displaying the process parameters in graphical time based diagrams are hard to interpret when there are more than approximately ten parallel process variables.

Advanced statistical and data mining methods/tools for trouble shooting (e.g. EXCEL™, Umetrics multivariate tool SIMCA™, MATLAB™, SPOTFIRE DECISION SITE™), are normally difficult to perform, and require a large amount of user interaction (mouse clicks, selection in lists, and text entering), and therefore are conducted by skilled engineers, not the operator that controls the process. The fact that different persons control the process and execute the troubleshooting generates costly time delays between deviation and execution of the corrective actions, such as a change in control setpoints.

Conventional methods have the following problems:

Statistical analysis normally requires a large number of user interactive actions and therefore is not suitable for an operator that needs to focus on a live manufacturing process.

Statistical analysis normally requires a large number of process parameters that need to be selected and exported from the controls systems, or central logsystems, such as OPC (Object linking and embedding for Process Control)—historians or SQL (Structured Query Language)—databases.

Selection of parameters takes time, and normally requires knowledge of parameter identities.

Creation of queries to access data requires special knowledge in data querying languages.

Retuned data often requires cleaning of non valid data, e.g. removal of data when processes have not been in operation.

Execution of the statistical tools/algorithms can be difficult to set up.

Validation of the statistical result is difficult.

Human communication of the statistical result to the operator can be difficult and lead to misunderstandings.

### SUMMARY OF THE INVENTION

It is an object of the present invention to address the problems mentioned above. According to aspects of the invention, an operator can easily find the cause of a problem, and find a solution that solves it, understand complex process behaviors, avoid bottlenecks, and find optimal operating strategies with a minimum of mouse clicks and knowledge of mathematics.

The invention herein is thus a method for visualizing mathematical explanations of an industrial response process parameter on a computer with a minimum of user interactions, comprising: defining an initial data set (10) for a data source (1) using a library of displays (3) presenting data associated with process parameters (14) that contains graphical representation (14) of the process parameters (12), the initial data set (10) containing time-based process parameter data; defining a suitable data import time range (7); marking data on an interactive data chart to trigger an explanation algorithm (20) and display an explanation algorithm result (21); and validating the explanation algorithm result (21).

### BRIEF DESCRIPTION OF THE DRAWINGS

FIG. 1 is a schematic view of an example of information flow to generate a time limited data set containing data for process parameters, where the process parameters are defined by process parameters available in a set of process displays.

FIG. 2 is a schematic view of an example of information flow to generate a ranked explanation list of process parameters explaining changes of a response process parameters based on a user interaction in charts and process displays.

FIG. 3 is a schematic view of an example of software solution implementing the invention.

FIG. 4 is a schematic view of an example of an enhanced detailed explanation result window with a Time Adjustment Control to improved handling of time delays.

FIG. 5 is a schematic view of an example of solution where the invention is integrated in a control system HMI, for example, SCADA-systems (Supervisory Control and Data Acquisition-System).

FIG. 6 is a schematic view of an example of solution where the invention is integrated as stand alone software connected to a plant wide information system

The examples shown schematically in the figures are non-limiting examples of the invention disclosed and claimed herein.

### DETAILED DESCRIPTION OF THE INVENTION AND PREFERRED EMBODIMENTS THEREOF

As discussed in more detail below, the invention herein is a method, system and product for visualizing mathematical explanations of an industrial response process parameter on a computer with a minimum of user interactions, comprising: defining an initial data set (10) for a data source (1) using a library of displays (3) presenting data associated with process parameters (14) that contains graphical representation (14) of the process parameters (12), the initial data set (10) containing time-based process parameter data; defining a suitable data import time range (7); marking data on an interactive data chart to trigger an explanation algorithm (20) and display an explanation algorithm result (21); and validating the explanation algorithm result (21). The system can be stored on a computer-readable medium, and run from a computer with an operating system such as, for example but not limited to, Windows, MacOS, Unix or Linux. It is understood that the invention herein requires use of a computer as known in the art.

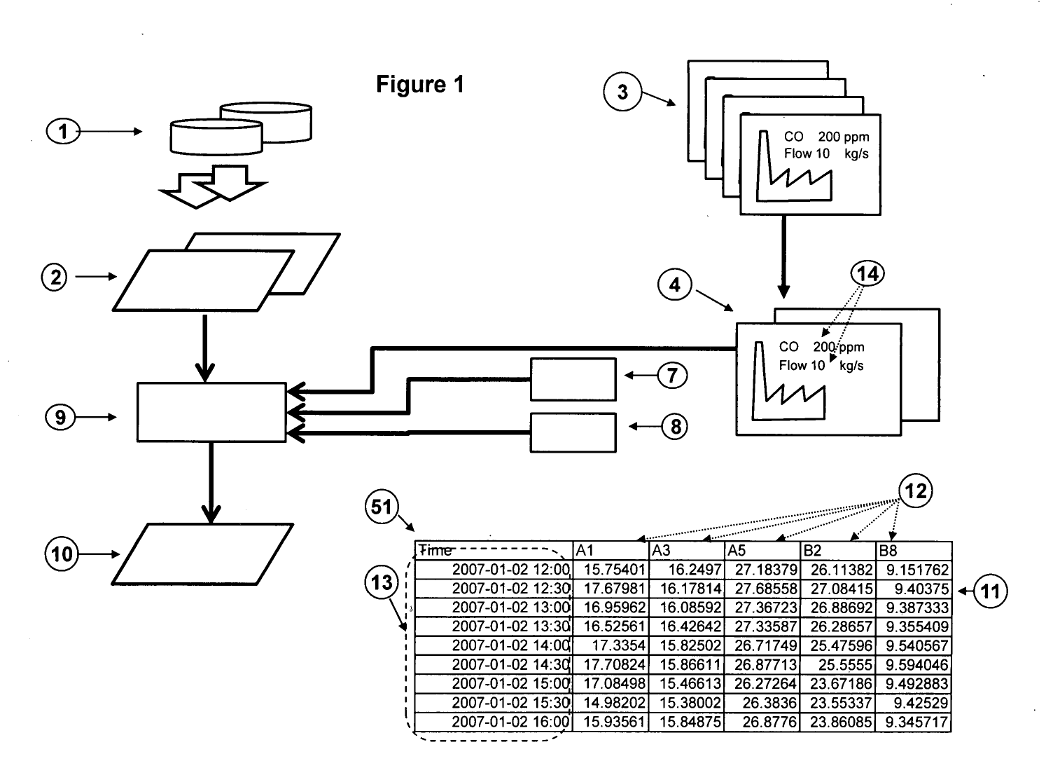

Referring now to the figures, FIG. 1 shows an example of information flow to generate a time limited data set containing data for process parameters, where the process parameters are defined by process parameters available in a set of process displays. Data sources (1) containing time based data are shown. Examples of data sources (1) are SQL-databases (Structured Query Language), OPC-historians, LIMS (Lab Information Management Systems), Excel spreadsheets, Electronic logbooks including time associated text reports, MES-systems (Manufacturing Execution System), or binary log data storages in control systems.

Data sets (2) from data sources (1) are preferably retrieved through standard methods as SQL-querying, OPC, or customized drivers.

A library of displays (3) presenting data associated with process parameters is shown. Normally these schematic displays are used for process monitoring/control, e.g. Control system,SCADA, MES, LIMS-displays/reports, or user defined displays. These displays contain graphical representations (14) of the process parameters (12), e.g., text boxes with real time data, dynamic bars, and lab report data. The graphical representation (14) of process parameters (12) on the defined subset of displays (4), substantially defines the process parameters (12) used by the explanation algorithm (20).

An initial data set creator (9) generates a merged initial data set (10) suitable for the explanation algorithm (20) based upon the graphical representation (14) of process parameters (12) on the defined subset of displays (4), a data import time range (7), and process parameter data available in the data sources (1), and preferably, data filters (8).

The data import time range (7) may be a automatically set, or set by the user, e.g. a user dialog where the user selects start time, end time of data.

The initial data set (10) is a time based data set suitable for fast filtering and statistical calculations by the explanation algorithm (20). The data set could be of any structure, e.g. lists, arrays, record sets.

An initial data set (64) may be structured as shown in FIG. 1, for example, as a record set containing record(s) (11) containing time stamps (13) and time based data for the process parameters (12) used by the explanation algorithm (20). The example demonstrates a merged initial data set (64) of parameters A1,A3,A5 from one data source (1), and B1,B8 from another data source (1), where A1,A3,A5,B1,B8 exists as graphical representations (14) of process parameters (12) in a subset of displays (4).

The initial data set (10) is preferably stored in the computer RAM-memory for very fast filtering, and execution of an explanation algorithm (20) without need of re-querying of data from the data sources (1).

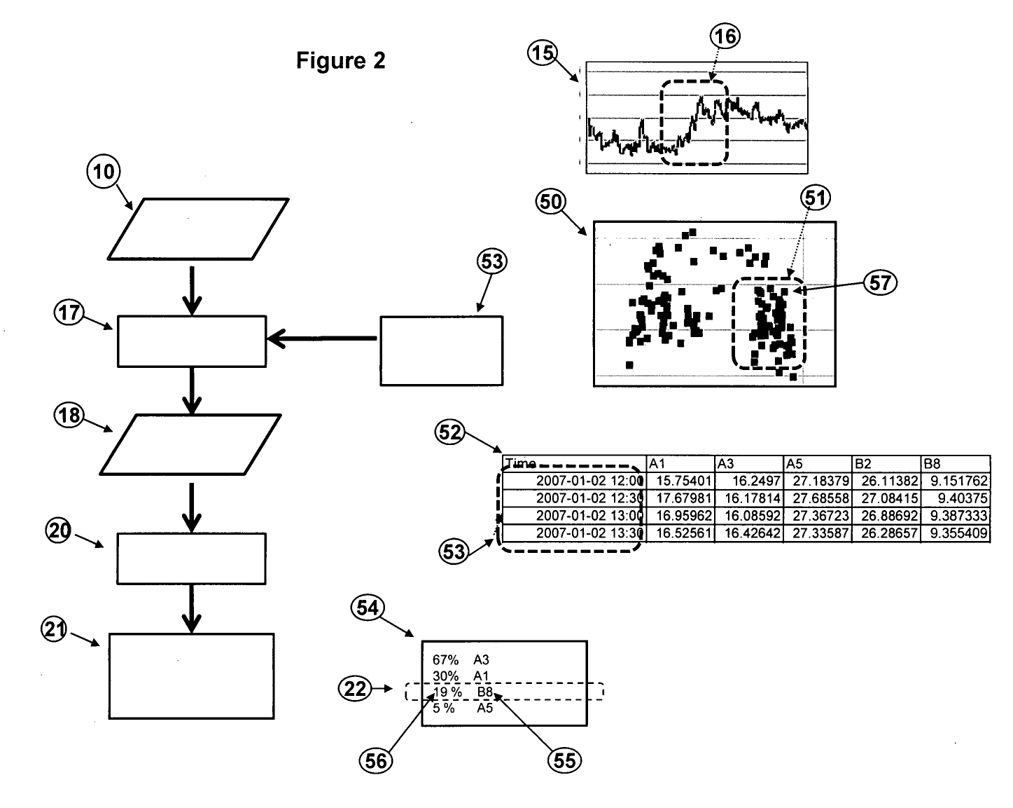

FIG. 2 shows an example of information flow to generate a ranked explanation list of process parameters explaining changes of response process parameters based on user interaction in charts and process displays. An interactive graphical chart (53) is shown displaying time based process data for one or more process parameters in the initial data set (10), where the user can select/mark data for analysis. The definition (17) of the analysis data set (18) is based upon a selection of the data in an interactive graphical chart (53), where the marked values' associated time points define the analysis data set (18) to be used by the explanation algorithm (20). The analysis data set (18) could be of any format suitable for the explanation algorithm (20), e.g. lists, arrays, record sets, hash tables, or other binary formats.

An example of an analysis data set (18) is a subset of the example of initial data set (64) including records (11) defined by the marked values' time stamps in an interactive graphical chart (53). Explanation algorithm (20) calculates explanation degrees between process parameters and one or more response variables in the analysis data set (18). The explanation algorithm (20) is preferably triggered by the selection of data in an interactive graphical chart (53).

An explanation algorithm result (21) for a response parameter is displayed in ranked order based upon explanation degree between a response parameter and process parameters available in the analysis data set (18).

FIG. 2 also shows an example of output of the explanation algorithm result (21), where the explaining process parameters for a response variable are listed in explanation degree order, and a collection of ranked list items (22), where each ranked list item (22) displays the explaining process parameter name (55) and explanation degree (56).

An example of output displayed as a ranked list (54) is shown, where the explaining process parameters, for a response variable, are listed in explanation degree order, a collection of ranked list items (22).

An example of an interactive line chart (15) implemented as an interactive graphical chart (53), and a definition of an analysis data set (18) by marking (16) of data on a line chart (15) is also shown in FIG. 2.

Also shown is an example of an interactive line chart (15) implemented as an interactive graphical X/Y-chart (50), with a selection of value pair markers (51), where each marked value pair (57) represents time points that are used to define the analysis data set (18).

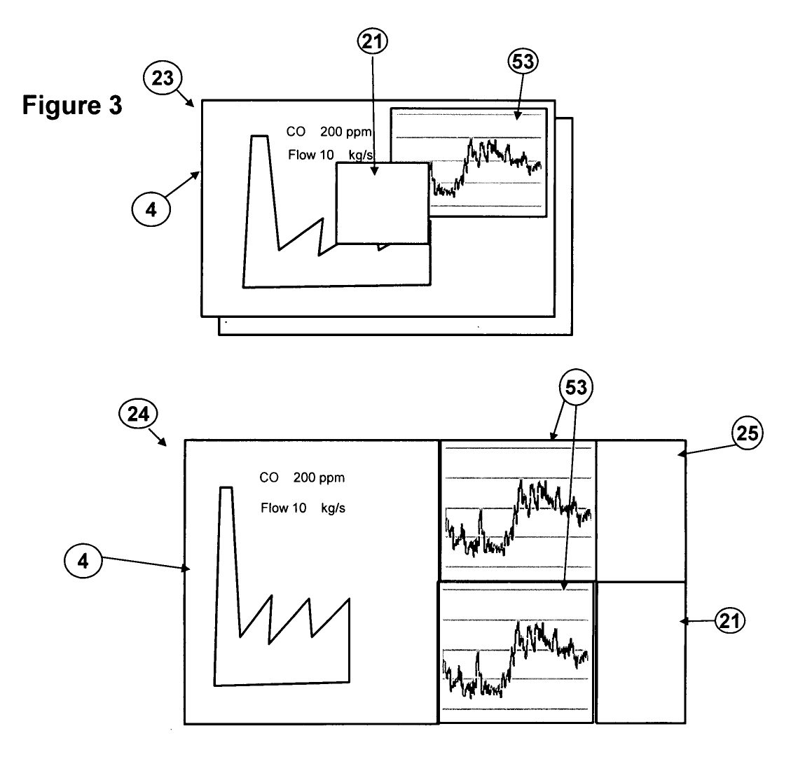

FIG. 3 shows an example of software solution implementing the invention. In this example, the invention is implemented as overlapping windows software (23) including subset of displays (4), an interactive graphical chart (53) and the output displayed as a ranked list item (22) implemented as an overlapping window or pop-up window. Overlapping windows are a common way of displaying logged data in control system HMI. The overlapping windows may normally be moved, hidden, resized and maximized.

The output displayed as a ranked list item (22) is preferably displayed as a pop-up window, when a mouse is near, or over, a graphical representation (14) of process parameters (12) in a display or in an interactive graphical chart (53).

An example is shown of a solution with multiple interactive graphical charts (24) including a subset of displays (4), interactive graphical charts (53) a filter control window (25) for interactively filtering data for the process parameters (12) with use of e.g. sliders, check boxes, item sliders, radio buttons, and the output from the explanation algorithm (20) displayed as a ranked list (22) within a dedicated window. A user can further filter/limit the time points with process data in the analysis data set (18) by setting minimum and maximum ranges.

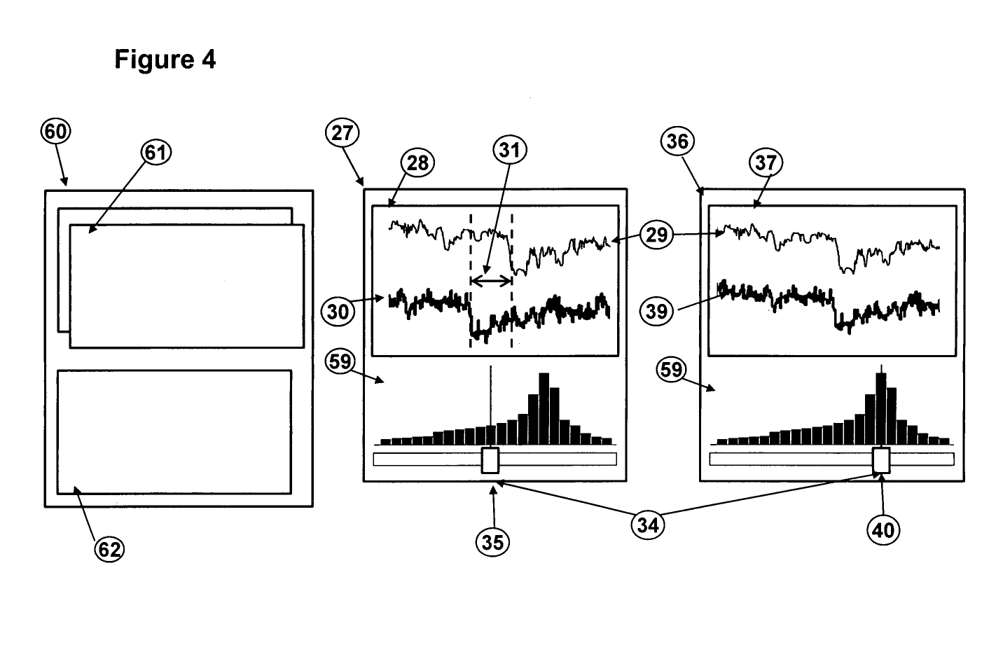

FIG. 4 shows an example of an enhanced detailed explanation result window with a Time Adjustment Control to improved handling of time delays. A detailed explanation result window (60) is used for fast validation of explanation algorithm results (21), and for overview and adjustments of time delays between process parameters. The detailed explanation result window (60) contains detailed relation graphs (61) displaying at least the response and an explaining process parameter, a time adjustment control (62) that displays the relation strength at different time adjustments between the response and an explaining process parameter.

Both the detailed relation graphs (61) and the time adjustment control (62) can be interactive, where the user can, preferably, but not limited to, using a mouse, select different time adjustments, and the detailed relation graphs (61) are preferably updated to conform with the selected time adjustment. The detailed relation graphs (61) can be implemented as any type of charts, e.g. line charts, bar-charts, x/y-charts.

An example of implementation of a detailed explanation result window (60) is shown as a line chart based detailed explanation result window (27) that contains a line chart (28) as implementation of detailed relation graphs (61) containing the explaining parameter (29) and response parameter (30) where the curves describe an example of time delay between a response and explaining parameter (31).

An example of implementation of the time adjustment control (62) is shown as a bar chart based time adjustment control (59) containing a bar chart where the height of each bar shows the explanation degree for different time adjustments between the explaining and response parameter. For example, the time adjustment bar located at zero time adjustment (35) displays the explanation degree at no time adjustment, and a time adjustment bar (40) representing 4 hours time adjustment displays the explanation degree, when the process parameter is adjusted 4 hours in time (39).

Preferably, when the user clicks on a time adjustment bar, e.g. the time adjustment bar (40) representing 4 hours time adjustment, a corresponding time adjustment is executed on the analysis data set (36) and executes the explanation algorithm on the modified data set.

Preferably, time adjustment is also executed by dragging the time adjustment thumb (34), where the thumb's position is related to a specific time adjustment.

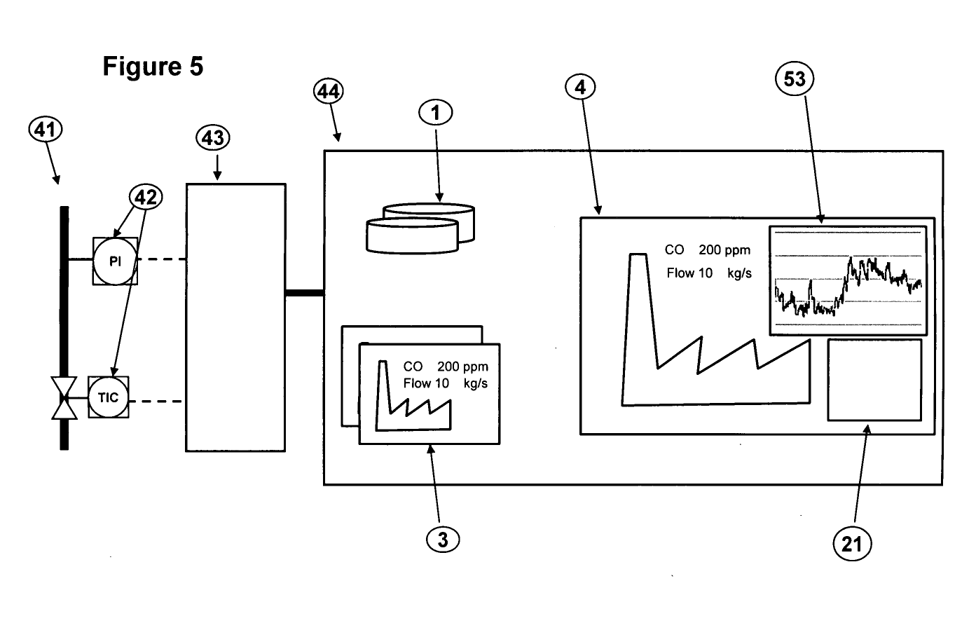

FIG. 5 shows an example of a solution where the invention is integrated in a control systems HMI or SCADA-system (44). An example is shown where the invention is integrated in a control systems HMI or SCADA-system (44) containing a library of displays (3) that is used for control/monitor of a manufacturing process (41), field process control equipment (42), I/O and process control computer(s) (43) e.g. a PLC (Programmable logic controller) or DCS-system (Distributed Control System), data sources (1), subset of displays (4), interactive graphical chart(s) (53) and functionality that enables display of an explanation algorithm result (21).

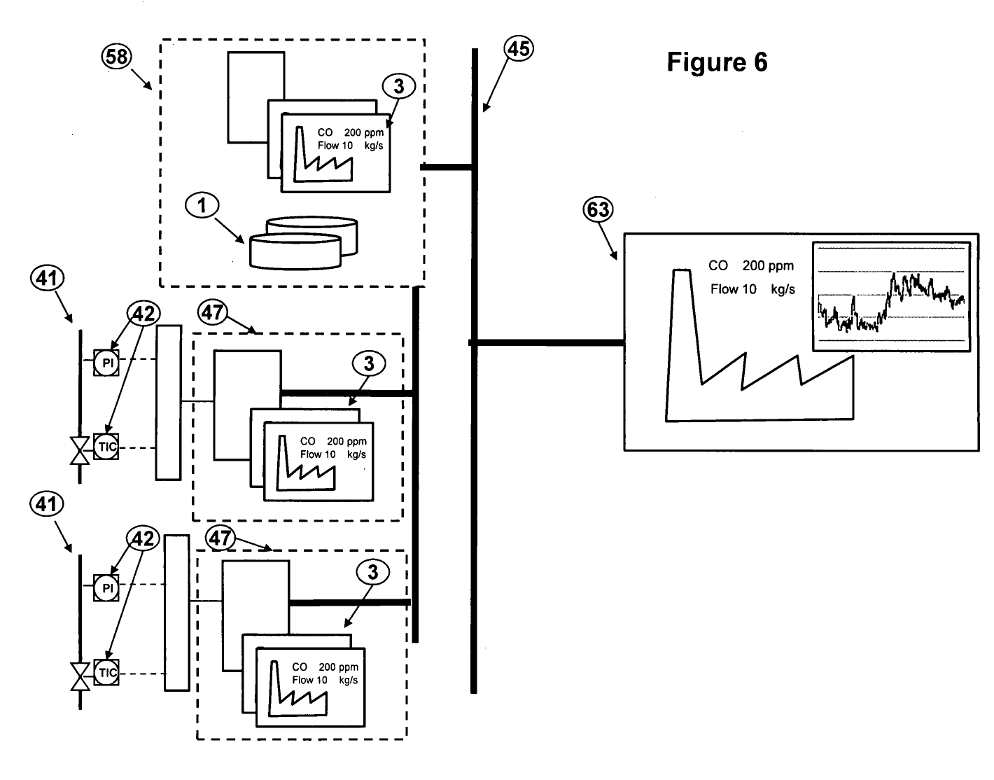

FIG. 6 shows an example of a solution where the invention is integrated as stand alone software connected to a plant wide information system. An example of a solution is shown where the invention is integrated as extended functionality of a plant wide information system as a stand alone software, containing multiple control systems (47) with multiple libraries of displays (3), connected to a the plant wide information system (58), with central data sources (1) for storage of process and lab data, and a standalone software implementing the invention (63) that retrieves data sets (2) from data sources (1) over the internal network (45). The standalone software implementing the invention (63) is executed on a suitable computer connected to the internal network (45), e.g. a server or desktop computer.

Examples of commercial plant wide information systems are INFORMATION MANAGEMENT SYSTEM™ from ABB, Zurich, Switzerland, MOPS™ from TietoEnator, Espoo,Finland and, PI SYSTEM™ from OSIsoft, San Leandro, Calif., USA

Description of the Invention Based on a Use Case

The use case describes the invention, in a non-limiting way, through a use case where a machine operator uses an implementation of the software to find the root cause of process disturbance in form of increase in NOx emissions in a recovery boiler, as follows:
1) The user starts to define a suitable initial data set (10) to be analyzed by:
   i) Opening subset of displays (4) containing process parameters that are believed to have an impact of a problem, e.g. ABB control system displays of a recover boiler in a pulp mill. The graphical representation (14) of process parameters (12) on the subset of displays (4) defines which data process parameters are to be included in the initial data set (10). Preferably, the machine operator has the software already open for process monitoring, and therefore not need open any additional displays.
   ii) The user defines a suitable data import time range (7) that is as input when filling the initial data set (10). The time range and resolution can be standard settings, or done through a specific dialog. Preferably, the user of the software has the software already open for process monitoring, and the initial data set (10) is continuously updated with new data from the data sources (1), and by that, the user does not need to perform any additional data loading commands.
   iii) The user selects NOx-emissions as response parameter by marking a corresponding graphical representation of process parameters (12). Examples of graphical representations are numeric fields containing real time data, curves in interactive line charts, legends, axis in graphs, labels, legends, sliders, icons, etc.
   iv) The user chooses the event for which to get the explanation (i.e. the NOx increase) by defining the analysis data set (18), e.g. by marking (16) of data in a line chart (15) that contains the NOx-increase. Preferably, both the response parameter and the analysis data set (18) defined by the single user interaction when marking the NOx increase in a line chart.
2) The marking of data Interactive line chart (15) and by that the definition (17) of the analysis data set (18), triggers the execution of the explanation algorithm (20).
3) The explanation algorithm result (21) is then displayed in a separate window, or in a pop window, e.g. tool-tip window that is automatically opened when a mouse cursor is over, near, or in any other way such as known in the art marks a graphical representation that is associated with the process parameter.
4) Preferably the explanation algorithm result output is displayed as a ranked list (54) with ranked list items (22) showing the explanation degree (56) and the associated explaining process parameter name (55). This allows the user to browse the result very fast without any further mouse clicks.
5) An example of an explanation degree between a response parameter and an explaining parameter is the coefficient of determination (R2) in linear regression analysis.
6) Preferably, the fields representing process parameters on the subset of displays (4) or interactive graphical charts (53), displays the current real time data, or an average of the process parameters values in the analysis data set (18)
7) Detailed validation of the explanation algorithm result (21) is preferably done by moving the mouse cursor over ranked list items (22), and when the mouse cursor is near/over ranked list items (22), a secondary detailed explanation result window (60) is displayed, that preferably contains details of the explanation calculation result, together with detailed relation graphs (61) displaying the response parameter and the explaining parameter.
8) The detailed explanation result window (60), is preferably automatically closed when the mouse cursor is moved outside the ranked list items (22), and a new detailed explanation result window (60) is displayed when the mouse is moved to next ranked list items (22). This enables very fast browsing and validation of the explanation algorithm result for a large number of explaining parameters without mouse clicks, in an intuitive relevance order.
9) With a further enhanced detailed explanation result window containing a time adjustment control (62), time delay between a response and explaining parameter (31) can be handled in an improved way. For example, the user moves the mouse over bars, in the bar chart based time adjustment control (59) and the line chart displaying the response and explaining parameter (29) is updated with a time adjustment defined by the bars associated time adjustment. This makes it possible for the user to browse the correlations for a large set of time adjustments without any mouse click. Preferably, when the user clicks on a bar in the bar chart based time adjustment control (59), a time adjustment performed on the analysis data set (18) and new explanation algorithm result is catapulted and displayed.
10) This makes it possible for the user with only a few mouse clicks to find and validate an explanation of an event, as as NOx-emission increase.

### EXAMPLE

i) The user observes an increase in NOx that originates from a, unknown, fuel dry content change.
ii) The user marks the NOx increase in a graph, and by that defines the data set time period, and NOx emissions as the initial response parameter.
iii) The explanation algorithm result (21) output is displayed as a ranked list (54).
iv) The user browses the result list for each explaining parameter, by just moving the mouse cursor over the ranked list item (22) that opens line chart based detailed explanation result windows (27).
v) The user thinks the flue gas O₂ content is the explanation of the NOx increase, and selects O₂ as response parameter by clicking any graphical representation of the flue gas O₂ process parameter.
vi) The user browses the new explaining explanation algorithm result (21) with flues gas O₂ content as response parameter, and detects that the fuel dry content has changed and by that finds the root cause.

This example shows a user interaction where the user, with only one mouse click and one mouse selection action, performs a complete mathematical response and explanation analysis in seconds. Preferably, the mouse click to select a process parameter as a response variable is replaced by just moving the mouse cursor near or over a process parameter graphical representation. This makes it possible to obtain the complete action with only one mouse selection action.

By starting background calculations for every process parameter (12) used by the explanation algorithm (20) as response variable, the statistical results of the calculations can be ready before the user selects a new response variable. For example, when there are changes to a response parameter from NOx-emission to flue gas O2 content, the explanation algorithm result (21) is immediately available for browsing without delay. This makes event flow tracking very fast.

Another aspect of the invention is that the user can select data for specific operation situations, such as dependencies at a certain production rate, through selection of value pair markers (51) in an interactive graphical X/Y-chart (50). For example, by selection of value pair markers (51) in an X/Y chart with axis of the steam production, and fuel flow, the user can find the explanation of the variations in an analysis data set (18) defined by the selected steam production, and fuel flow ranges.

It is understood that the steps and components of the invention herein may be programmed by one of ordinary skill in the art having knowledge of the invention herein as described and shown, using programming methods and parameters as defined herein and as known in the art.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A method for visualizing mathematical dependencies between industrial response process parameters on a computer with a minimum of user interactions, comprising:
a. defining an initial data set (10) for a data source (1) using a library of displays (3) presenting data associated with process parameters (14) that contain graphical representation (14) of the process parameters (12), the initial data set (10) containing time-based process parameter data;
b. defining a suitable data import time range (7);
c. marking data on an interactive data chart to trigger an explanation algorithm (20) and display an explanation algorithm result (21); and
d. validating the explanation algorithm result (21).

2. The method according to claim 1, further comprising displaying the explanation algorithm result in a list in explanation degree order and where ranked list items (2) correspond to explaining process parameters.

3. The method according to claim 1, further comprising basing the explanation algorithm (20) on multivariate linear regression.

4. The method according to claim 1, further comprising basing the explanation algorithm (20) frequency analysis (eg Fast Fourier Transform).

5. The method according to claim 1, wherein the interactive graphical chart (53) is a time based line chart.

6. The method according to claim 1, wherein the interactive graphical chart (53) is an x/y chart.

7. The method according according to claim 1, wherein the interactive graphical chart (53) is a bar chart.

8. The method according to according to claim 1, wherein the execution of the explanation algorithm (20) is triggered by the event of a user executing a selection of data in an interactive graphical chart (53).

9. The method according to claim 1, wherein the explanation algorithm result (21) is displayed, without a computer mouse click, when the mouse is near, or over a graphical representation (14) of process parameters (12).

10. The method according to claim 1, wherein a filter control window (25) containing interactive filters for process parameters (12) is used by the explanation algorithm (20) such that a user can further filter/limit the time points with process data in the analysis data set (18) by setting minimum and maximum ranges.

11. The method according to claim 1, further comprising using an interactive line chart (15) where a user can select a displayed process parameter, which is represented in the interactive line chart (15) with a curve, and a time adjustment by moving the curve along a time line on the interactive line chart, and by that time adjusting corresponding data in the analysis data set (18).

12. The method according to claim 1, wherein the initial analysis data set (10) is automatically updated with new data from data sources (1) when new data is available.

13. The method according to claim 9, further comprising moving a mouse over a ranked list item (22) in a window with resultant output displayed as a ranked list (54), and a detailed explanation result window (60) display characterized by containing detailed information about the explanation algorithm result (21) associated with the ranked list item (22) and associated explaining parameter and response parameter.

14. The method according to claim 13 wherein the detailed explanation result window (60) contains at least a line chart displaying a response parameter and an explaining parameter (28) with the response parameter and the explaining parameter associated to a ranked list item (22)

15. The method according to claim 13 wherein the detailed explanation result window (60) contains at least a graphical x/y chart displaying a response parameter and an explaining parameter (28) with the response parameter and the explaining parameter associated to a ranked list item (22).

16. The method according to 11, further comprising an automatic calculation of the time adjustment that gives the best explanation degree between a process parameter and a response parameter.

17. The method according to claim 11 wherein a time adjustment control (62) in a detailed explanation result window (60) is characterized by showing an explanation degree at different time adjustments between a response process parameter and an explaining parameter.

18. The method according to claim 17 wherein a detailed relation graph (61) is time adjusted according to user interaction with the time adjustment control (62).

19. The method according to claim 18 wherein a user interaction with the time adjustment control (62) executes a time adjustment to the analysis data set (18) that results in an update of the explanation algorithm result (21) according to the updated time adjusted analysis data set (18).

20. A system for visualizing mathematical dependencies between industrial response process parameters on a computer with a minimum of user interactions, comprising:
a. a defined initial data set (10) for a data source (1) having a library of displays (3) presenting data associated with process parameters (14) and containing graphical representation (14) of the process parameters (12), the initial data set (10) containing time-based process parameter data;
b. a defined suitable data import time range (7);
c. means for marking data on an interactive data chart to trigger an explanation algorithm (20) and display an explanation algorithm result (21); and
d. means for validating the explanation algorithm result (21).

21. A computer-readable medium having stored therein instructions that, when executed by a computer, cause the computer to perform the method of claim 1.
